(19) United States
(12) Patent Application Publication
(10) Pub. No.: US 2014/0305334 A1
(43) Pub. Date: Oct. 16, 2014

(54) MOUNTING STRUCTURE FOR DRIVING UNIT AND DRIVEN UNIT OF LOCOMOTIVE

(71) Applicant: ELECTRO-MOTIVE DIESEL, INC., LaGrange, IL (US)

(72) Inventors: James Leonard Blase, Lemont, IL (US); Steven Tai, Chicago, IL (US)

(73) Assignee: Electro-Motive Diesel, Inc., LaGrange, IL (US)

(21) Appl. No.: 13/861,574

(22) Filed: Apr. 12, 2013

(51) Int. Cl. B61C 17/00; B61C 7/04; B60K 5/12

(52) U.S. Cl. CPC B61C 17/00; B60K 5/1208; B61C 7/04
USPC 105/26.05; 248/562

(57) ABSTRACT

A mounting structure for a driving unit and a driven unit of a locomotive is provided. The mounting structure includes a cradle, and an isolation system. The cradle includes a first portion, and a second portion. The first portion is configured to receive the driving unit therein. The second portion axially extends from the first portion and is configured to receive the driven unit therein. The isolation system is disposed on an outer surface of the cradle. The isolation system is configured to engage with a chassis of the locomotive to reduce transfer of vibrations from the driving unit, and the driven unit into the chassis.

### TECHNICAL FIELD

The present disclosure relates to a mounting structure and more particularly to a mounting structure for a driving unit, and a driven unit of a locomotive.

### BACKGROUND

Typically, vehicles including a driving unit or a driven unit may contain one or more rotating or reciprocating components disposed therein, for example, a locomotive including a reciprocating engine containing pistons therein, or a locomotive including a gas turbine engine or a multi-stage compressor containing rotating blades therein. Further, the driving unit and the driven unit may be rigidly mounted on a chassis of the vehicle, and in some cases; a cab structure may also be mounted on the chassis to house the driving unit and the driven unit.

During an operation of the vehicle, various forces and/or moments of the rotating and reciprocating components may produce vibrations. These vibrations when transferred to the chassis may cause the chassis to become weak. In some cases, the vibrations may be of a frequency substantially close to a natural frequency of the chassis and this may cause the chassis to resonate and ultimately fail under prolonged exposure to the vibrations. Further, in cases where the driving and driven units are housed within the cab structure, the vibrations may resonate within the cab and produce undesirable noise. Therefore, while the vibrations may hinder a working of the vehicle, the noise may have a negative impact on a health of operating personnel associated with the vehicle.

Although some previously known damping systems may be used to dampen the vibrations and prevent the aforementioned effects, the damping systems may be tedious to design and may utilize expensive manufacturing processes. Such damping systems may also be of inadequate strength to withstand the weights and the vibrations of the driving and driven units, thus proving unreliable in operation.

U.S. Pat. No. 8,151,757 (757 patent) relates to an oil pan/axle support. The oil pan/axle support is a structural member which places the front axle support in front of the engine. The oil pan/axle support includes a rigid structural housing capable of forming a portion of a frame of a vehicle. The housing has an aft portion and a forward portion. The aft portion forms an engine oil reservoir surrounded by a rim. The rim has an upwardly facing sealing surface for engagement with a block of an engine. The forward portion extends forward from the aft portion and forms a pair of fore-and-aft spaced apart pivot bores for receiving a front axle pivot pin so that the front axle is spaced forward with respect to a front portion of the engine. However, the '757 patent does not disclose about reducing vibrations from the engine block to the frame of the vehicle.

### SUMMARY

In one aspect, the present disclosure provides a mounting structure for a driving unit and a driven unit of a locomotive. The mounting structure includes a cradle, and an isolation system. The cradle includes a first portion, and a second portion. The first portion is configured to receive the driving unit therein. The second portion axially extends from the first portion and is configured to receive the driven unit therein. The isolation system is disposed on an outer surface of the cradle. The isolation system is configured to engage with a chassis of the locomotive to reduce transfer of vibrations from the driving unit, and the driven unit into the chassis.

In another aspect, the present disclosure provides a locomotive including a chassis, a driving unit, a driven unit, and a mounting structure. The driven unit is operatively connected to the driving unit. The mounting structure includes a cradle, and an isolation system. The cradle includes a first portion, and a second portion. The first portion is configured to receive the driving unit therein. The second portion axially extends from the first portion and is configured to receive the driven unit therein. The isolation system is disposed on an outer surface of the cradle. The isolation system is configured to engage with the chassis to reduce transfer of vibrations from the driving unit, and the driven unit into the chassis.

Other features and aspects of this disclosure will be apparent from the following description and the accompanying drawings.

### BRIEF DESCRIPTION OF THE DRAWINGS

FIG. 1 is a front perspective view of an exemplary locomotive in accordance with an embodiment of the present disclosure;

FIG. 2 is a front perspective view of a cradle employed in the exemplary locomotive of FIG. 1;

FIG. 3 is an front view of an exemplary isolation system;

FIG. 4 is a front perspective view of a mounting structure in an assembled state with a driving unit and a driven unit of the locomotive; and

FIG. 5 is an exploded view of the cradle and the driving unit.

### DETAILED DESCRIPTION

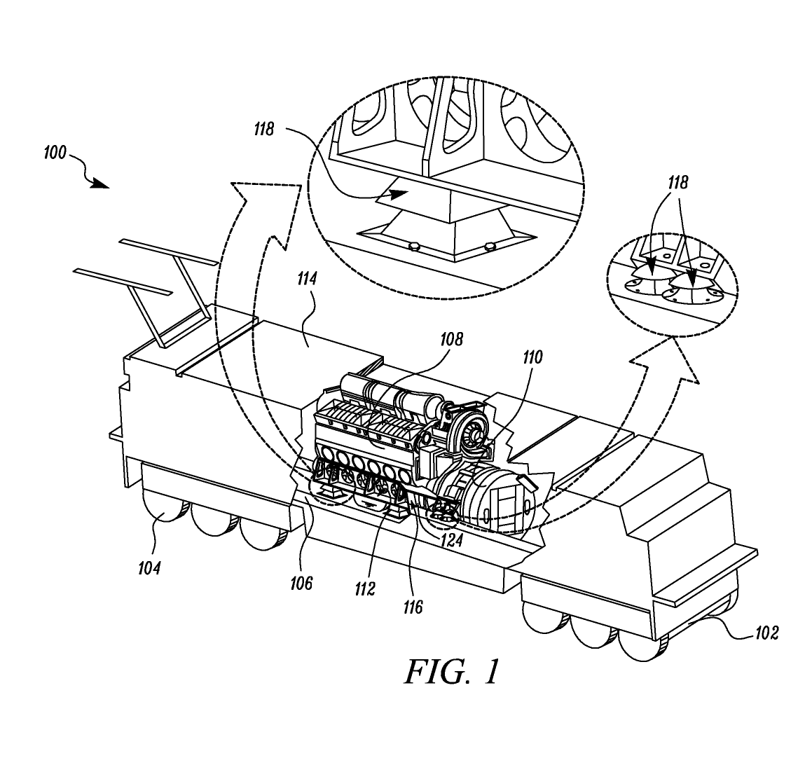

The present disclosure relates to a mounting structure for a driving unit, and a driven unit of a locomotive. FIG. 1 shows a front perspective view of the locomotive 100 in which disclosed embodiments may be implemented. In an embodiment, the locomotive 100 may be an industrial locomotive configured to pull cargo containers (not shown). In another embodiment, the locomotive 100 may be a commercial locomotive configured to pull passenger cars (not shown).

The locomotive 100 includes two or more axles 102. In an embodiment as shown in FIG. 1, the locomotive 100 may include six axles 102 associated with wheels 104. The locomotive 100 may further include a chassis 106, a driving unit 108, a driven unit 110 and a mounting structure 112. The chassis 106 is disposed on the axles 102. In an embodiment as shown in FIG. 1, the locomotive 100 may further include a cab 114 rigidly mounted on the chassis 106. The cab 114 may be configured to house the driving unit 108, the driven unit 110 and the mounting structure 112.

The driven unit 110 is operatively connected to the driving unit 108. In one embodiment, the driving unit 108 may be an engine, and the driven unit 110 may be a generator coupled to the engine. In one embodiment, the engine may be a rotary engine such as a gas turbine engine, which may be used to drive the generator for power generation. In other embodiments, the engine may be a reciprocating engine, such as a diesel engine configured to drive a compressor.

The mounting structure 112 is configured to mount the driving unit 108, and the driven unit 110 onto the chassis 106. The mounting structure 112 includes a cradle 116, and one or more isolation system 118. The cradle 116 includes a first portion 120, and a second portion 122 axially extending from the first portion 120. The first portion 120 is configured to receive the driving unit 108 therein. The second portion 122 is configured to receive the driven unit 110 therein. The isolation system 118 is disposed on an outer surface 124 of the cradle 116. The isolation system 118 is configured to engage with the chassis 106 of the locomotive 100 to reduce transfer of vibrations from the driving unit 108, and the driven unit 110 into the chassis 106.

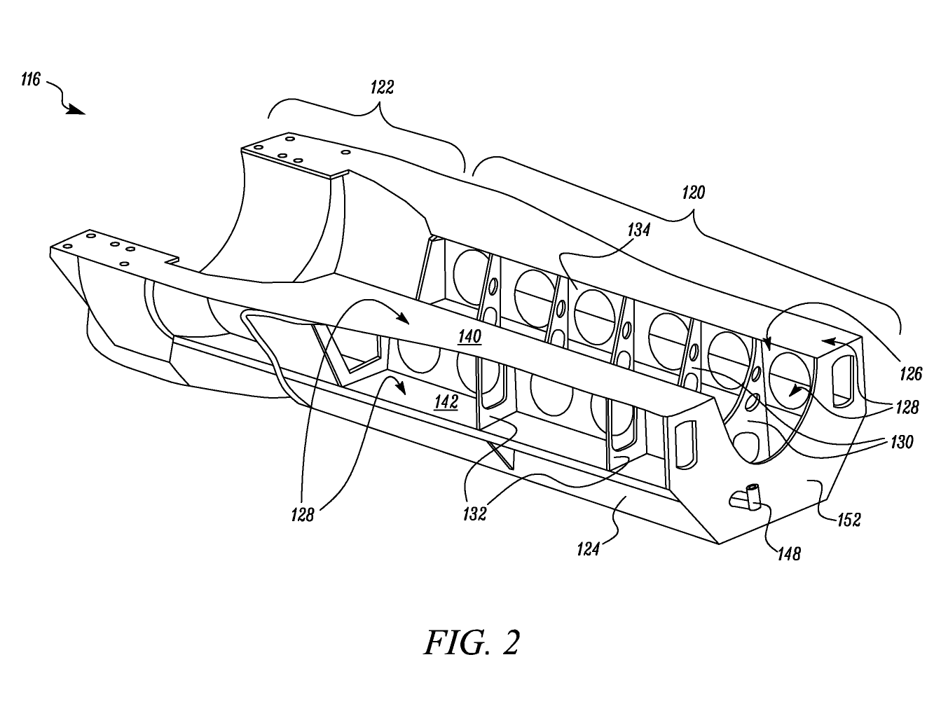

In an embodiment as shown in FIG. 2, the cradle 116 is of a substantially semi-cylindrical shape. In alternative embodiments, the cradle 116 may be of other shapes having an internal profile conjugate to a contour of the driving unit 108 and the driven unit 110. In other embodiments, various lengths and widths of the cradle 116 may be selected such that the first portion 120 and the second portion 122 accommodate a length and width of the driving unit 108 and the driven unit 110 respectively. Therefore, it is to be noted that the substantially semi-cylindrical shape of the cradle 116 disclosed herein is merely exemplary in nature, and hence, non-limiting of this disclosure. Any suitable shape, size and internal profile may be used to form the cradle 116 depending on the contour of the driving unit 108 and driven unit 110.

In an embodiment as shown in FIG. 2, the cradle 116 may further include a pair of side walls 126, and one or more flanges 128. The side walls 126 extend upwardly from the first portion 120 and the second portion 122 while the flanges 128 laterally extend from the side walls 126.

In an exemplary embodiment as shown in FIG. 2, the pair of side walls 126 may include one or more ribs 130, and one or more webbings 132. The ribs 130 may be rigidly attached on an inner surface 134 of the side walls 126 while the webbings 132 may be disposed on an outer surface 124 and rigidly attached to the flanges 128. The ribs 130 and webbings 132 disclosed herein may be configured to impart strength and rigidity to the side wall 126 such that the side wall 126 may support a weight, and vibrations of the driving unit 108 and the driven unit 110.

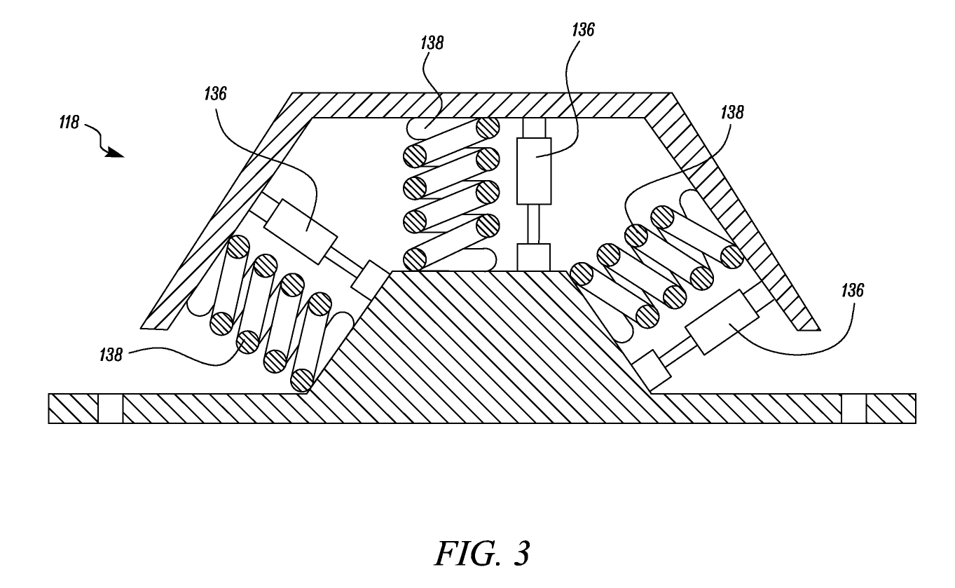

In one embodiment, the isolation system 118 may include dampers 136. In another embodiment, the isolation system 118 may include springs 138. In another embodiment as shown in FIG. 3, the isolation system 118 may include a combination of dampers 136 and springs 138. In another embodiment, the isolation system 118 disclosed herein, may be of a type that can be adjustably tuned so that the isolation system 118 is configured to reduce amplitude of vibrations in a desired manner or to a desired extent in a given amount of time. Therefore, it is to be noted that the aforesaid embodiments pertaining to the isolation system 118 are provided merely for exemplary purposes, and hence should not be construed as limiting of this disclosure. Any type of isolation system 118 commonly known in the art such as hydraulic, mechanical, magnetic systems may be used to reduce transfer of vibrations from the driving unit 108, and the driven unit 110 into the chassis 106.

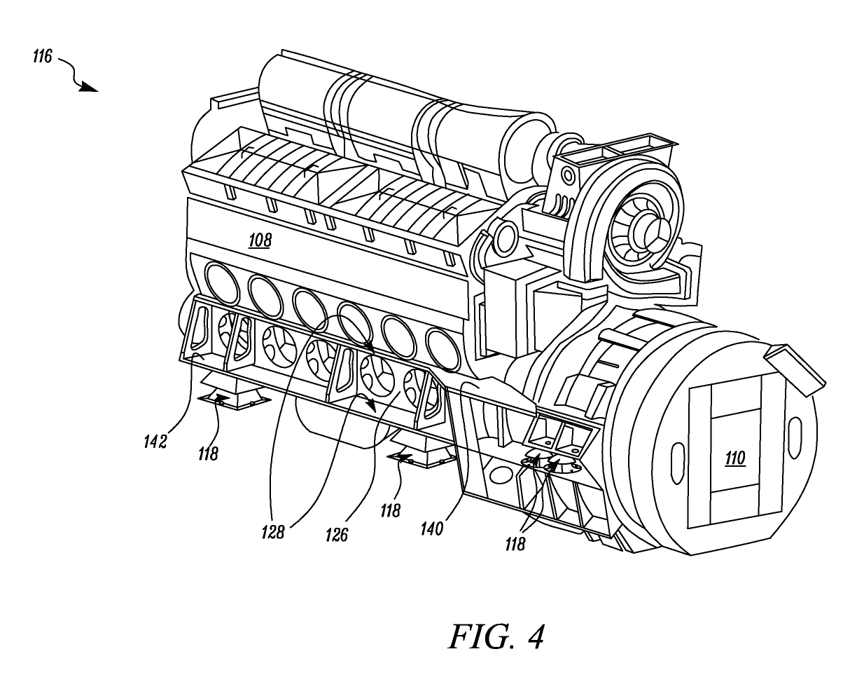

In an exemplary embodiment as shown in FIG. 4, the isolation system 118 is releasably engaged with the flanges 128. In one embodiment as shown in FIG. 4, the flanges 128 may collectively represent a pair of flanges 140, 142 so as to include a top flange 140 and a bottom flange 142. The top flange 140 may be configured to releasably engage with the driving unit 108 and the driven unit 110 while the bottom flange 142 may be engaged with the isolation system 118. In one embodiment, the releasable engagement disclosed herein, may be accomplished by threaded fasteners, such as threaded bolts that may be configured to engage with threaded receptacles in the driving unit 108, the driven unit 110, and the isolation system 118. However, in other embodiments, various other types of fasteners commonly known in the art may be used to accomplish the releasable engagement disclosed herein.

Although it is disclosed in the preceding embodiment that the flanges 128 may be the top flange 140 and the bottom flange 142, the top flange 140 and the bottom flange 142 are merely exemplary in nature, and hence, non-limiting of this disclosure. Any number of flanges 128 may be used to releasably fasten with the driving and the driven unit 108, 110 while also engaging with the isolation system 118. In another embodiment, the flanges 128 may be one singular flange (not shown) laterally extending from the side wall 126. The singular flange may include a top side, and a bottom side. The top side may be configured to releasably fasten with the driving and the driven unit 108, 110 while the bottom side may be releasably fastened to the isolation system 118.

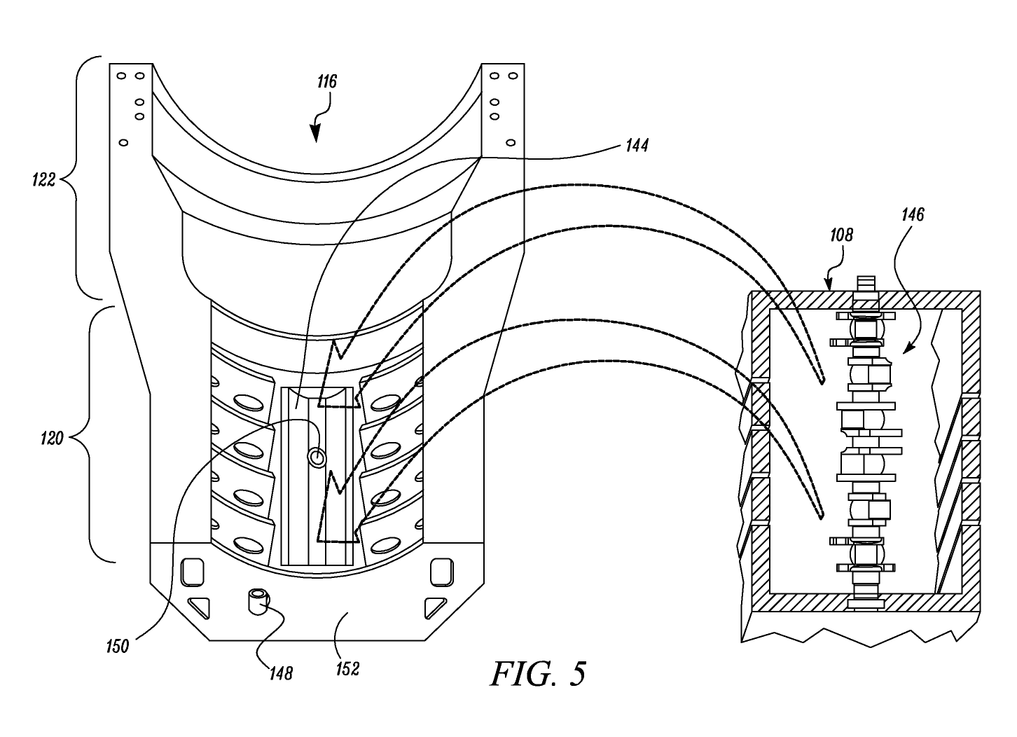

In an embodiment as shown in FIG. 5, the first portion 120 may include an oil pan 144. The oil pan 144 may be configured to face an underside 146 of the driving unit 108 and store oil. A depth of the oil pan 144 may be selected such that rotating or reciprocating components present in the driving unit 108 may pick up a pre-determined amount of oil from the oil pan 144 during each operational sweep executed by the components, for example, cheeks on a crankshaft of a reciprocating engine may pick up oil from the oil pan 144 and splash it over a cylinder lining of the reciprocating engine.

In an embodiment as shown in FIG. 5, the first portion 120 may further include a fill port 148, and a drain plug 150. The fill port 148 may be disposed on an end wall 152 of the cradle 116, and may be configured to allow oil to be filled into the cradle 116 and the oil pan 144 therein. The drain plug 150 may be disposed on the oil pan 144 and may be configured to allow oil to be drain out of the oil pan 144 under a force of gravity or by any forced means.

### INDUSTRIAL APPLICABILITY

Typically, vehicles including a driving unit or a driven unit may contain one or more rotating or reciprocating components disposed therein, for example, a locomotive including a reciprocating engine containing pistons therein, or a locomotive including a gas turbine engine or a multi-stage compressor containing rotating blades therein. Further, the driving unit and the driven unit may be rigidly mounted on a chassis of the vehicle, and in some cases; a cab structure may also be mounted on the chassis to house the driving unit and the driven unit.

During an operation of the vehicle, various forces and/or moments of the rotating and reciprocating components may produce vibrations. These vibrations when transferred to the chassis may cause the chassis to become weak. In some cases, the vibrations may be of a frequency substantially close to a natural frequency of the chassis and this may cause the chassis to resonate and ultimately fail under prolonged exposure to the vibrations. Further, in cases where the driving and driven units are housed within the cab structure, the vibrations may resonate within the cab and produce undesirable noise. Therefore, while the vibrations may hinder a working of the vehicle, the noise may have a negative impact on a health of operating personnel associated with the vehicle.

Although some previously known damping systems may be used to dampen the vibrations and prevent the aforementioned effects, the damping systems may be tedious to design and may utilize expensive manufacturing processes. Such damping systems may also be of inadequate strength to withstand the weights and the vibrations of the driving and driven units, thus proving unreliable in operation.

However, during a manufacture of the cradle 116, commonly known methods of sheet metal fabrication such as shearing, forming, welding, and the like may be used. Typically, these sheet metal fabrication methods are quick, easy, and economical to perform. Therefore, based on a known relative positioning of the driving unit 108, and the driven unit 110 on the chassis 106 of the locomotive 100, the cradle 116 may be manufactured and assembled quickly.

Further, with the mounting structure 112 of the present disclosure, the cradle 116 may include webbings 132 and ribs 130 that are structurally integrated with the side walls 126 and the flanges 128. Such webbings 132 and ribs 130 are configured to impart strength to the side walls 126 and the flanges 128 while the side walls 126 and flanges 128 encounter vibrations from the driving and driven units 108, 110 respectively. Therefore, the cradle 116 may be constructed using the webbings 132 and the ribs 130 to offer adequate strength while supporting a weight and the vibrations experienced during operation of the driving and driven units 108, 110.

Further, the isolation system 118 located on the cradle 116 such that the isolation system 118 are configured to abut the chassis 106, and resiliently dispose the cradle 116 on the chassis 106. Various parameters of this isolation system 118 are selected such that a possibility of resonance within the chassis 106 or the cab 114 may be mitigated or minimized. Various models and methods commonly known in the art may be used to design the isolation system 118 such that the isolation system 118 may be configured to modulate amplitude and/or a frequency of vibrations from the driving and driven units 108, 110 before transferring the vibrations to the chassis 106 or the cab 114. Therefore, the isolation system 118 may cause a mismatch in excitation frequency of the vibrations from the driving and driven units 108, 110 with respect to a natural frequency of the cab 114 or the chassis 106 to prevent resonance in the cab 114 or the chassis 106. Thus, the cab 114 or the chassis 106 may not be subjected to weakening during operation of the locomotive 100. Therefore, use of the isolation system 118 along with the cradle 116 disclosed herein may prolong a service life of the cab 114 and the chassis 106.

While aspects of the present disclosure have been particularly shown and described with reference to the embodiments above, it will be understood by those skilled in the art that various additional embodiments may be contemplated by the modification of the disclosed machine, systems and methods without departing from the spirit and scope of what is disclosed. Such embodiments should be understood to fall within the scope of the present disclosure as determined based upon the claims and any equivalents thereof.

We claim:

1. A mounting structure for a driving unit, and a driven unit of a locomotive, the mounting structure comprising:
a cradle including:
a first portion configured to receive the driving unit therein; and
a second portion axially extending from the first portion and configured to receive the driven unit therein; and
an isolation system disposed on an outer surface of the cradle, the isolation system configured to engage with a chassis of the locomotive and reduce transfer of vibrations from the driving unit, and the driven unit into the chassis.

2. The mounting structure of claim 1, wherein the cradle is of a substantially semi-cylindrical shape.

3. The mounting structure of claim 2, wherein the cradle further includes:
a pair of side walls upwardly extending from the first portion and the second portion; and
one or more flanges laterally extending from the side walls.

4. The mounting structure of claim 3, wherein the isolation system is releasably engaged with the flanges.

5. The mounting structure of claim 4, wherein the isolation system includes one or more of dampers, and springs.

6. The mounting structure of claim 3, wherein the flanges include:
a top flange configured to releasably engage with the driving unit, and the driven unit; and
a bottom flange engaged with the isolation system.

7. The mounting structure of claim 3, wherein the flanges include:
a top side configured to releasably fasten with the driving unit, and the driven unit; and
a bottom side releasably fastened to the isolation system.

8. The mounting structure of claim 3, wherein the pair of side walls include:
one or more ribs rigidly attached on an inner surface of the side wall; and
one or more webbings disposed on an outer surface and rigidly attached to the flanges.

9. The mounting structure of claim 1, wherein the first portion includes an oil pan, the oil pan is configured to face an underside of the driving unit and store oil.

10. A locomotive including:
a chassis;
a driving unit;
a driven unit operatively connected to the driving unit; and
a mounting structure including:
a cradle including:
a first portion configured to receive the driving unit therein; and
a second portion axially extending from the first portion and configured to receive the driven unit therein; and
an isolation system disposed on an outer surface of the cradle, the isolation system configured to engage with the chassis and reduce transfer of vibrations from the driving unit, and the driven unit into the chassis.

11. The locomotive of claim 10, wherein the cradle is of a substantially semi-cylindrical shape.

12. The locomotive of claim 11, wherein the cradle further includes:
a pair of side walls upwardly extending from the first portion and the second portion; and
one or more flanges laterally extending from the side walls.

13. The locomotive of claim 12, wherein the isolation system is releasably engaged with the flanges.

14. The locomotive of claim 13, wherein the isolation system includes one or more of dampers, and springs.

15. The locomotive of claim 12, wherein the flanges include:
a top flange configured to releasably engage with the driving unit, and the driven unit; and
a bottom flange engaged with the isolation system.

16. The locomotive of claim 12, wherein the flanges include:
a top side configured to releasably fasten with the driving unit, and the driven unit; and
a bottom side releasably fastened to the isolation system.

17. The locomotive of claim 12, wherein the pair of side walls include:
one or more ribs rigidly attached on an inner surface of the side wall; and
one or more webbings disposed on an outer surface and rigidly attached to the flanges.

18. The locomotive of claim 10, wherein the first portion includes an oil pan, the oil pan is configured to face an underside of the driving unit and store oil.

19. The locomotive of claim 10, wherein the driving unit is one of an engine and an electric motor.

20. The locomotive of claim 10, wherein the driven unit is one of a generator and a compressor.
